(19) United States
(12) Patent Application Publication
(10) Pub. No.: US 2012/0311695 A1
(43) Pub. Date: Dec. 6, 2012

(54) METHOD AND APPARATUS FOR DYNAMIC MODIFICATION OF AUTHENTICATION REQUIREMENTS OF A PROCESSING SYSTEM

(76) Inventors: Tobias M. Kohlenberg, Portland, OR (US); Steven A. Mancini, Forest Grove, OR (US)

(21) Appl. No.: 13/118,798

(22) Filed: May 31, 2011

(51) Int. Cl. H04L 9/32

(52) U.S. Cl. 726/16

(57) ABSTRACT

Authentication requirements for a user to access a processing system may be dynamically modified based on status information received from sensors coupled to the processing system. The processing system may receive a request for access to the processing system by the user. The processing system determines an authentication policy based at least in part on the status information, and presents authentication requirements to the user based at least in part on the authentication policy.

### FIELD

The present disclosure generally relates to the field of authentication in processing systems. More particularly, an embodiment of the invention relates to dynamically modifying authentication requirements for a user of a processing system.

### BACKGROUND

Currently, determining authentication requirements in processing systems is typically a binary condition. That is, a potential user of a processing system is required to either authenticate himself or herself to the processing system or not, prior to use. There are no options for variable levels of authentication requirements depending on the likelihood that an attack on the processing system is occurring, or on other conditions. More flexibility in determining authentication requirements is desired.

### BRIEF DESCRIPTION OF THE DRAWINGS

The detailed description is provided with reference to the accompanying figures. The use of the same reference numbers in different figures indicates similar or identical items.

FIG. 1 is a diagram of a processing system according to an embodiment of the present invention.

FIG. 2 is a diagram of dynamic modification of authentication requirements processing according to an embodiment of the present invention.

FIGS. 3 and 4 illustrate block diagrams of embodiments of processing systems, which may be utilized to implement some embodiments discussed herein.

### DETAILED DESCRIPTION

Embodiments of the present invention describe a method and apparatus to implement dynamic modification of authentication requirements for a processing system, depending on the detection of evidence that supports the presence of a legitimate user. This enables strong authentication of the user in some circumstances, without the highly intrusive or potentially irritating requirement of entering a strong password in every situation.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs stored on a computer readable storage medium (“software”), or some combination of hardware and software. For the purposes of this disclosure reference to “logic” shall mean either hardware, software (including for example micro-code that controls the operations of a processor), firmware, or some combination thereof.

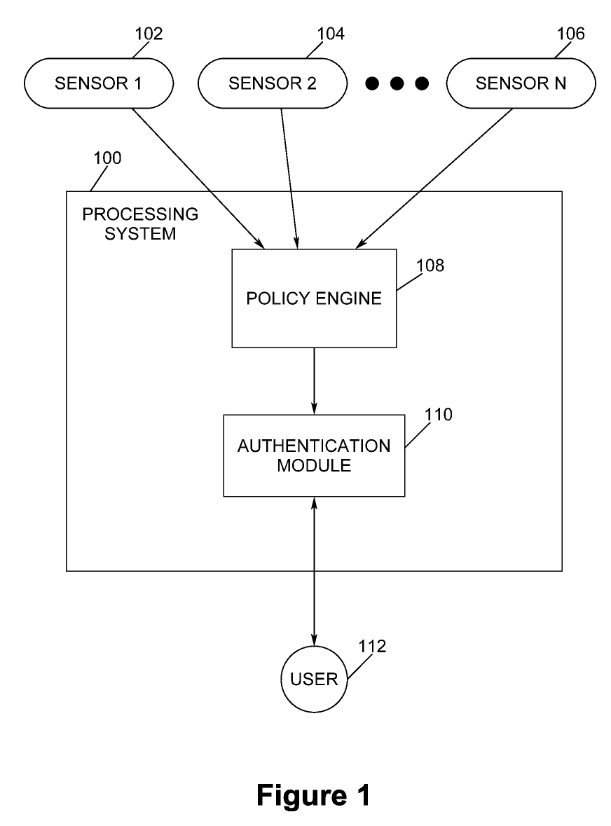

FIG. 1 is a diagram of a processing system according to an embodiment of the present invention. In various embodiments, processing system 100 may be a cell phone or smart phone, a personal computer (PC), a laptop computer, a netbook, a tablet computer, a handheld computer, a mobile Internet device (MID), a personal digital assistant (PDA), or any other stationary or mobile processing device. Processing system 100 interacts with one or more sensors 102, 104, and 106. In an embodiment, each sensor may be at least a part of any processing device that is communicatively coupled with the processing system. In various embodiments, there may be multiple processing devices communicatively coupled to the processing system, with each processing device containing a sensor. In various embodiments, a sensor may comprise or be integral with a processing device such as a cell phone, smart phone, PC, laptop computer, netbook, tablet computer, handheld computer, MID, music player device, wireless router, wireless access point, telephone headset, camera, geographic positioning system (GPS) device, antenna, remote control device, television, employee badge, key fob, smart card, dongle, portable storage device, or other electronic device.

In an embodiment, a sensor may provide evidence of the presence of the processing device to the processing system 100. In an embodiment, a sensor may provide evidence of the proximity of the processing device to the processing system 100 or a current communications interaction between the processing device and the processing system. In another embodiment, a sensor may sense either an internal or external environmental condition of the processing system. A sensor may obtain status information relating to a processing device or of the processing system.

In embodiments of the present invention, communications mechanisms between a processing device and the processing system may include Bluetooth radio, WiFi radio, WiMax, radio frequency identification (RFID), infrared, near field communications (NFC) radio, or other communications technologies. In embodiments of the present invention, it may be assumed that the user may be carrying or be in proximity to multiple processing devices (e.g., smart phone, music player, Bluetooth headset, tablet computer, etc.), other than the processing system.

Processing system 100 comprises a policy engine 108 and an authentication module 110. In an embodiment, policy engine 108 defines rules for what level of authentication is required for the user of the processing system in different situations, depending at least in part on status information provided by the one or more sensors. A unique collection of rules for authentication of the user to the processing system may be known as an authentication policy. In an embodiment, there may be multiple authentication policies specified within policy engine 108. In an embodiment, authentication policies may be created and/or updated by system administrators for the owner of multiple processing systems (e.g., an information technology (IT) group in a corporate environment). In another embodiment, authentication policies may be created and/or updated by the user.

In an embodiment, policy engine 108 receives sensor status information from the one or more sensors 102, 104, and 106, and determines a relevant authentication policy based on the sensor status. The policy engine may then instruct the authentication module 110 to request and accept specific kinds of authentication information from the user 112 based on the selected authentication policy. The authentication module may receive the user's input data and determine if the user is authenticated for further use of the processing system based at least in part on the received input data and the selected authentication policy. In another embodiment, the policy engine and the authentication module may be integrated into a single component within the processing system.

In one example, an authentication policy may specify that if there is a currently active Bluetooth connection between the user's Bluetooth headset and the user's cell phone and the processing system is currently communicatively coupled to the user's work or home wireless network access point, then the requirements for authentication of the user may include requiring the user to enter a personal identification number (PIN) of a specified length (such as four or numeric six digits, for example) into the processing system, instead a strong password. In an embodiment, a strong password may have particular requirements, such as one or more of: having a minimum length of characters, using at least one upper case letter, using at least one number, using at least one special character (e.g., !@#$%̂&*, etc.), comprising a pass phrase of multiple words, not using any of or be substantially similar to a specified number previously used passwords, and so on. That is, the PIN may be easier and quicker for the user to enter into the processing system than a complex, strong password. The use of the PIN may provide less security than the use of the strong password, but since the device has been determined to be physically at a work or a home location (or any location where theft is deemed less likely to occur) where the user is using his or her phone, this level of security may be deemed to be acceptable in this particular situation. More generally, according to embodiments of the present invention, the authentication requirements for the user may be dynamically modified depending on the currently sensed conditions of the processing system and other processing devices of the user that are interacting with the processing system.

In another example, an authentication policy may specify that if there is a currently active Bluetooth connection between the user's Bluetooth headset and the user's cell phone and the user's RFID-enabled employee badge is detectable (providing evidence that makes it less likely the processing system has been stolen), then the requirements for authentication of the user may comprise requiring the user to enter a PIN into the processing system, instead a strong password. In this example, the processing system may be the user's cell phone, and the other processing devices are the Bluetooth headset and the RFID-enabled employee badge.

In another example, an authentication policy may specify that if there are no other processing devices belonging to the user that are detected when authentication is requested and the current geographic location is not trusted, then the requirements for authentication of the user may comprise requiring the user to enter a strong password, (or perhaps even a complex pass phrase) and provide evidence of a valid smart card or valid biometric data (one or more of fingerprint, thumb print, hand print, retina scan, live facial image, and so on). In this situation, it may be possible that the processing system has been stolen (since no other user devices are detected), so it may be appropriate to require higher authentication requirements.

In another example, if the user's current location as determined by one or more sensors is within a specified range of the processing system, the processing system remains accessible (e.g., unlocked). If the user's current location is not within the specific range, the processing system becomes inaccessible (e.g., locked). When the user gets back into range of the processing system, the requirements for unlocking may be modified based at least in part on the sensor status information received from sensors. For example, if the user comes back into range of the processing system (as determined by an RFID-enabled employee badge) and the user has in his or her possession the user's smart phone and Bluetooth headset, it may be inferred that the processing system is still in the possession of the user (i.e., has not been stolen), and the authentication requirements may be dynamically lowered. However, if a person who has stolen the user's employee badge and processing system (such as a laptop PC) tries to be authenticated, the authentication requirements may be different (e.g., higher) if the policy engine of the processing system does not also detect the user's cell phone, for example, according to a selected authentication policy.

In a still further example, the user's location as reported by a sensor may be used as part of an authentication policy. For example, if the user is at home, a first level of authentication may be required. If the user is at work, a second level of authentication may be required. If the user is in a public place, such as an airport, restaurant, or street corner, a third level of authentication may be required.

As can be seen from these examples, many different combinations of rules may be defined in an authentication policy based on sensor status information and detected processing devices according to embodiments of the present invention.

In an embodiment, the number of detected processing devices of the user may be used to determine, at least in part, an authentication policy. That is, the more user processing devices are detected, the lower the authentication requirements (i.e., lower than a default set of requirements); the fewer user processing devices are detected, the higher the authentication requirements (i.e., higher than a default set of requirements). For example, if the user's smart phone, Bluetooth headset, home wireless network, network-enabled television monitor, and music player are all detected by the user's laptop PC, the authentication policy for the laptop PC may be set to require only a PIN to be entered by the user. If only the user's smart phone is detected, the authentication policy may be set to require a simple alphabetic password. If none of these devices are detected, a strong password may be required. The number of processing devices needed to be present in order to trigger higher or lower authentication requirements may be a predetermined number. For example, when the number of processing devices present is more than the predetermined number, a first authentication policy having lower requirements than the default may be selected. When the number of processing devices present is less than or equal to the predetermined number, a second authentication policy having higher requirements than the default may be selected.

In an embodiment, an authentication policy may require the user to perform some specified action with one or more of the processing devices and/or the processing system as part of the dynamically modified authentication requirements. In one example, if a Bluetooth headset and a current communication between the headset and the processing system is detected, the authentication policy may require that the user speak a specified word or pass phrase into the microphone of the headset, for subsequent processing by the processing system. Other user actions affecting authentication may be employed in various embodiments of the present invention.

Thus, embodiments of the present invention process status information from sensors and use the sensor status to evaluate the likelihood that the user is actually present or that the processing system may have been stolen. Based at least in part on that sensor status information, the policy engine 108 of the processing system 100 makes a decision as to how suspect the processing system should be about the user's identity. By providing dynamic and graduated authentication requirements, the user experience can facilitate easy and quick access in scenarios of greater trust, but also convey a greater sense of concern with higher authentication requirements in less secure scenarios.

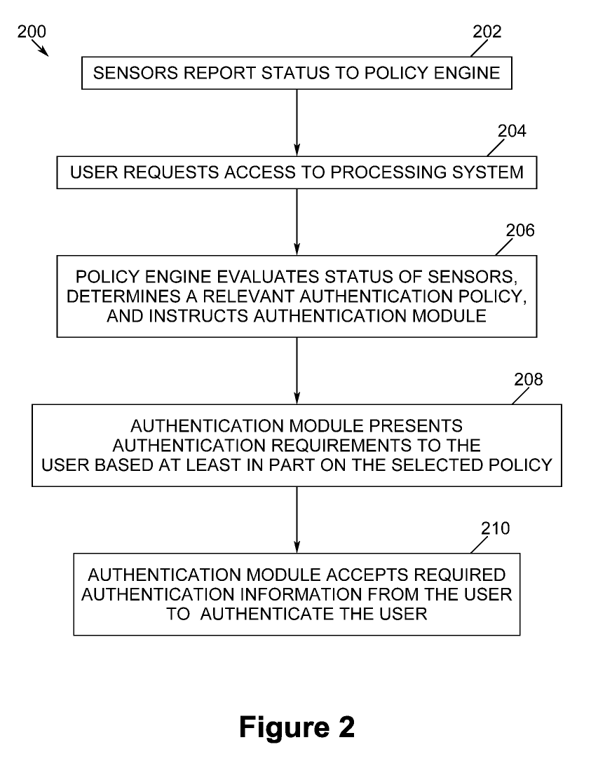

FIG. 2 is a diagram of dynamic modification of authentication requirements processing 200 according to an embodiment of the present invention. At block 202, one or more sensors 102, 104, and 106 report the status of their respective processing devices or sensed environmental conditions to the policy engine 108. Generally, the sensor status may indicate presence information of a processing device. In an embodiment, the sensor status may include the proximity of the processing device to the processing system. In another embodiment, the sensor status may include the communications connection status between the processing device and the processing system. In another embodiment, the sensor status may indicate a sensed environmental condition value. The frequency and format of reporting of sensor status information to the policy engine may be determined depending at least in part on the processing device and/or sensed condition, according to embodiments of the present invention. In at least one embodiment, the policy engine 108 may poll recognized sensors 102, 104, and 106 as needed.

At block 204, the user 112 requests access to the processing system 100. In an embodiment, block 204 may occur in parallel with block 202. In an embodiment, policy engine 108 polls the sensors either at a particular frequency or upon receipt of a user authentication request. At block 206, policy engine 108 evaluates the status of the sensors, determines a relevant authentication policy based at least in part on the received status of the sensors, and instructs the authentication module 206 to process the user authentication request according to the selected authentication policy. At block 208, the authentication module presents the dynamically determined authentication requirements to the user based at least in part on the selected authentication policy. At block 210, the authentication module accepts the required authentication information from the user in order to authenticate the user for access to the processing system.

In one usage scenario, the authentication requirements may be left unchanged at a default setting (such as a strong password, for example) based at least in part on the received sensor status. This may occur, for example, when there is a lack of supporting evidence for the user's identity and/or presence of other user processing devices based on the sensor status. In another usage scenario, the authentication requirements may be dynamically modified to a higher setting requiring increased authentication information. This may occur, for example, when there is an un-trusted location being detected and no evidence of the user's identity and/or presence from the sensors. The higher setting may involve the user having to enter multiple passwords or pass phrases, detection of a smart card or RFIRD-enabled employee badge, and/or a thumb print scan, for example. In a third usage scenario, the authentication requirements may be dynamically modified to a lower setting requiring decreased authentication information. This may occur, for example, when there is ample supporting evidence of the user's identity and/or presence. The lower setting may involve the user having to only enter a simple four digit PIN if the processing system detects the user's work wireless network, RFID-enabled employee badge, smart phone, and Bluetooth headset, for example.

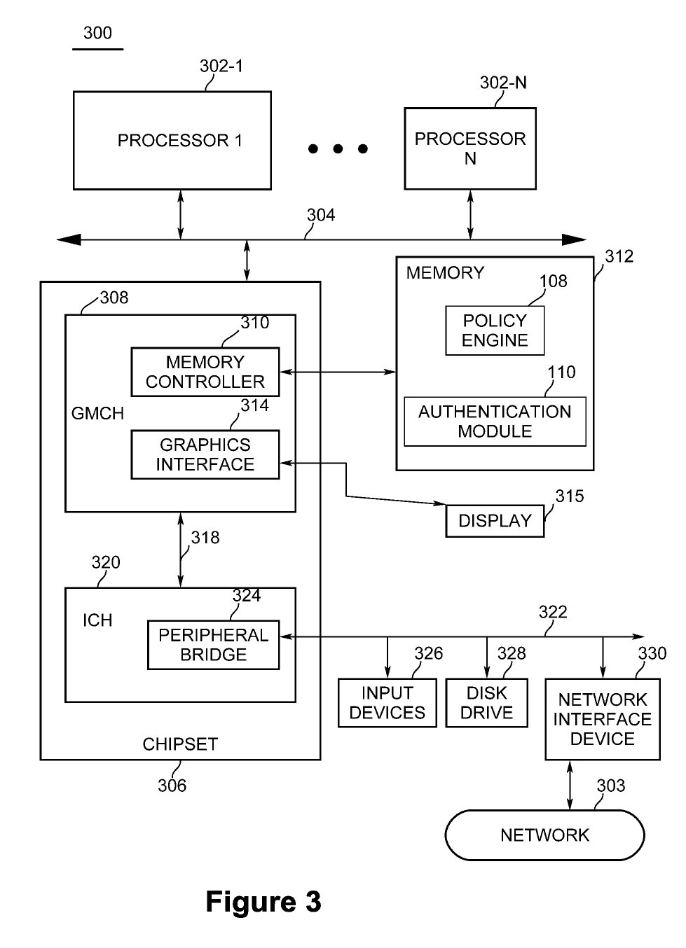

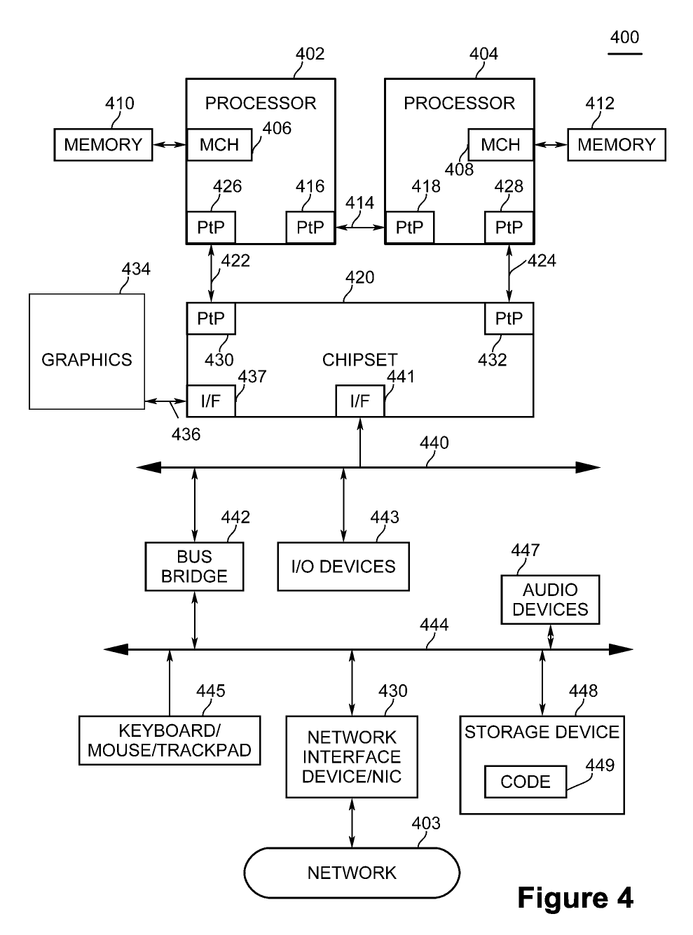

FIG. 3 illustrates a block diagram of one embodiment of a processing system 300. In various embodiments, one or more of the components of the system 300 may be provided in various electronic devices capable of performing one or more of the operations discussed herein with reference to some embodiments of the invention. For example, one or more of the components of the system 300 may be used to perform the operations discussed with reference to FIGS. 1-2, e.g., by processing instructions, executing subroutines, etc. in accordance with the operations discussed herein. Also, various storage devices discussed herein (e.g., with reference to FIG. 3 and/or FIG. 4) may be used to store data, operation results, etc. In one embodiment, data may be received over the network 303 (e.g., via network interface devices 330 and/or 430) may be stored in caches (e.g., L1 caches in an embodiment) present in processors 302 (and/or 402 of FIG. 4). These processors may then apply the operations discussed herein in accordance with various embodiments of the invention.

More particularly, the processing system 300 may include one or more processors 302 that communicate via an interconnection network (or bus) 304. Hence, various operations discussed herein may be performed by a processor in some embodiments. Moreover, the processors 302 may include a general purpose processor, a network processor (that processes data communicated over a computer network 303, or other types of a processor (including a reduced instruction set computer (RISC) processor or a complex instruction set computer (CISC)). Moreover, the processors 302 may have a single or multiple core design. The processors 302 with a multiple core design may integrate different types of processor cores on the same integrated circuit (IC) die. Also, the processors 302 with a multiple core design may be implemented as symmetrical or asymmetrical multiprocessors. Moreover, the operations discussed with reference to FIGS. 1-2 may be performed by one or more components of the system 300. In an embodiment, a processor (such as processor 1 302-1) may comprise policy engine 108 and/or authentication module 110 as hardwired logic (e.g., circuitry) or microcode.

A chipset 306 may also communicate with the interconnection network 304. The chipset 306 may include a graphics and memory control hub (GMCH) 308. The GMCH 308 may include a memory controller 310 that communicates with a memory 312. The memory 312 may store data and/or instructions. The data may include sequences of instructions that are executed by the processor 302 or any other device included in the processing system 300. Furthermore, memory 712 may store one or more of the programs or algorithms discussed herein such as policy engine 108 and/or authentication module 110, instructions corresponding to executables, mappings, etc. The same or at least a portion of this data (including instructions, and temporary storage arrays) may be stored in disk drive 328 and/or one or more caches within processors 302. In one embodiment of the invention, the memory 312 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 304, such as multiple processors and/or multiple system memories.

The GMCH 308 may also include a graphics interface 314 that communicates with touch screen display 110. In one embodiment of the invention, the graphics interface 314 may communicate with display 315 via an accelerated graphics port (AGP). In an embodiment of the invention, the display 315 may be a flat panel display that communicates with the graphics interface 314 through, for example, a signal converter that translates a digital representation of an image stored in a storage device such as video memory or system memory into display signals that are interpreted and displayed by the display 315. The display signals produced by the interface 314 may pass through various control devices before being interpreted by and subsequently displayed on the display 315. In an embodiment, policy engine 108 and/or authentication module 110 may be implemented as circuitry within the chipset.

A hub interface 318 may allow the GMCH 308 and an input/output (I/O) control hub (ICH) 320 to communicate. The ICH 320 may provide an interface to I/O devices that communicate with the processing system 300. The ICH 320 may communicate with a bus 322 through a peripheral bridge (or controller) 324, such as a peripheral component interconnect (PCI) bridge, a universal serial bus (USB) controller, or other types of peripheral bridges or controllers. The bridge 324 may provide a data path between the processor 302 and peripheral devices. Other types of topologies may be utilized. Also, multiple buses may communicate with the ICH 320, e.g., through multiple bridges or controllers. Moreover, other peripherals in communication with the ICH 320 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 322 may communicate with input devices 326 (such as a track pad, mouse, our other pointing input device), one or more disk drive(s) 328, and a network interface device 330, which may be in communication with the computer network 303 (such as the Internet, for example). In an embodiment, the device 330 may be a network interface controller (NIC) capable of wired or wireless communication. Other devices may communicate via the bus 322. Also, various components (such as the network interface device 330) may communicate with the GMCH 308 in some embodiments of the invention. In addition, the processor 302, the GMCH 308, and/or the graphics interface 314 may be combined to form a single chip.

Furthermore, the processing system 300 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 328), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

In an embodiment, components of the system 300 may be arranged in a point-to-point (PtP) configuration such as discussed with reference to FIG. 4. For example, processors, memory, and/or input/output devices may be interconnected by a number of point-to-point interfaces.

More specifically, FIG. 4 illustrates a processing system 400 that is arranged in a point-to-point (PtP) configuration, according to an embodiment of the invention. In particular, FIG. 4 shows a system where processors, memory, and input/output devices are interconnected by a number of point-to-point interfaces. The operations discussed with reference to FIGS. 1-2 may be performed by one or more components of the system 400.

As illustrated in FIG. 4, the system 400 may include multiple processors, of which only two, processors 402 and 404 are shown for clarity. The processors 402 and 404 may each include a local memory controller hub (MCH) 406 and 408 (which may be the same or similar to the GMCH 308 of FIG. 3 in some embodiments) to couple with memories 410 and 412. The memories 410 and/or 412 may store various data such as those discussed with reference to the memory 312 of FIG. 3.

The processors 402 and 404 may be any suitable processor such as those discussed with reference to processors 302 of FIG. 3. The processors 402 and 404 may exchange data via a point-to-point (PtP) interface 414 using PtP interface circuits 416 and 418, respectively. The processors 402 and 404 may each exchange data with a chipset 420 via individual PtP interfaces 422 and 424 using point to point interface circuits 426, 428, 430, and 432. The chipset 420 may also exchange data with a high-performance graphics circuit 434 via a high-performance graphics interface 436, using a PtP interface circuit 437. Graphics 424 may be coupled with a touch screen display 110 (not shown in FIG. 4).

At least one embodiment of the invention may be provided by utilizing the processors 402 and 404. For example, the processors 402 and/or 404 may perform one or more of the operations of FIGS. 1-2. Other embodiments of the invention, however, may exist in other circuits, logic units, or devices within the system 400 of FIG. 4. Furthermore, other embodiments of the invention may be distributed throughout several circuits, logic units, or devices illustrated in FIG. 4.

The chipset 420 may be coupled to an interconnection network 440 using a PtP interface circuit 441. The interconnection network 440 may have one or more devices coupled to it, such as a bus bridge 442 and I/O devices 443. Via a bus 444, the bus bridge 442 may be coupled to other devices such as a keyboard/mouse/track pad 445, the network interface device 430 discussed with reference to FIG. 3 (such as modems, network interface cards (NICs), or the like that may be coupled to the computer network 303), audio I/O device 447, and/or a data storage device 448. The data storage device 448 may store, in an embodiment, program code 449 for the policy engine 108 and/or authentication module 110 that may be executed by the processors 402 and/or 404.

In various embodiments of the invention, the operations discussed herein, e.g., with reference to FIGS. 1-4, may be implemented as hardware (e.g., logic circuitry), software (including, for example, micro-code that controls the operations of a processor such as the processors discussed with reference to FIGS. 3 and 4), firmware, or combinations thereof, which may be provided as a computer program product, e.g., including a tangible machine-readable or computer-readable medium having stored thereon instructions (or software procedures) used to program a computer (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A method of dynamically modifying authentication requirements for a user to access a processing system comprising:
receiving status information from at least one sensor coupled to the processing system;
receiving a request for access to the processing system by the user;
determining an authentication policy based at least in part on the status information; and
presenting authentication requirements to the user based at least in part on the authentication policy.

2. The method of claim 1, further comprising accepting required authentication information from the user to authenticate the user for access to the processing system.

3. The method of claim 1, wherein the at least one sensor is at least a part of a processing device communicatively coupled with the processing system.

4. The method of claim 3, wherein the at least one sensor provides evidence of the presence of the processing device to the processing system.

5. The method of claim 4, wherein the presence indicates at least one of proximity of the processing device to the processing system and communications interaction between the processing device and the processing system.

6. The method of claim 4, further comprising determining the authentication policy based at least in part on the number of processing devices present.

7. The method of claim 6, wherein determining the authentication policy comprises selecting an authentication policy with lower authentication requirements than a default set of requirements when the number of processing devices present is more than a predetermined number, and selecting an authentication policy with higher authentication requirements than a default set of requirements when the number of processing devices present is equal to or less than the predetermined number.

8. The method of claim 4, further comprising requiring the user to perform a specified action with the processing device as part of the authentication requirements defined by the selected authentication policy.

9. The method of claim 4, further comprising one of lowering the authentication requirements, raising the authentication requirements, and leaving the authentication requirements unchanged, as determined by the selected authentication policy.

10. A machine-readable medium comprising one or more instructions that when executed on a processor of a processing system, perform one or more operations to
receive status information from at least one sensor coupled to the processing system;
receive a request for access to the processing system by the user;
determine an authentication policy based at least in part on the status information; and
present authentication requirements to the user based at least in part on the authentication policy.

11. The machine-readable medium of claim 10, further comprising instructions to accept required authentication information from the user to authenticate the user for access to the processing system.

12. The machine-readable medium of claim 10, wherein the at least one sensor is at least a part of a processing device communicatively coupled with the processing system.

13. The machine-readable medium of claim 12, wherein the at least one sensor provides evidence of the presence of the processing device to the processing system.

14. The machine-readable medium of claim 13, wherein the presence indicates at least one of proximity of the processing device to the processing system and communications interaction between the processing device and the processing system.

15. The machine-readable medium of claim 13, further comprising instructions to determine the authentication policy based at least in part on the number of processing devices present.

16. The machine-readable medium of claim 13, further comprising instructions to one of lower the authentication requirements, raise the authentication requirements, and leave the authentication requirements unchanged, as determined by the selected authentication policy.

17. A processing system comprising:
a policy engine to receiving status information from at least one sensor coupled to the processing system and to determine an authentication policy based at least in part on the status information; and
an authentication module to receive a request for access to the processing system by the user and to present authentication requirements to the user based at least in part on the authentication policy.

18. The processing system of claim 17, wherein the authentication module is to accept required authentication information from the user to authenticate the user for access to the processing system.

19. The processing system of claim 17, wherein the at least one sensor is at least a part of a processing device communicatively coupled with the processing system.

20. The processing system of claim 19, wherein the at least one sensor provides evidence of the presence of the processing device to the processing system.

21. The processing system of claim 20, wherein the presence indicates at least one of proximity of the processing device to the processing system and communications interaction between the processing device and the processing system.

22. The processing system of claim 20, wherein the policy engine is adapted to determine the authentication policy based at least in part on the number of processing devices present.

23. The processing system of claim 22, wherein the policy engine is further adapted to determine the authentication policy by selecting an authentication policy with lower authentication requirements than a default set of requirements when the number of processing devices present is more than a predetermined number, and selecting an authentication policy with higher authentication requirements than a default set of requirements when the number of processing devices present is equal to or less than the predetermined number.

24. The processing system of claim 20, wherein the authentication module is adapted to require the user to perform a specified action with the processing device as part of the authentication requirements defined by the selected authentication policy.

25. The processing system of claim 20, wherein the authentication module is adapted to lower the authentication requirements, raise the authentication requirements, or leave the authentication requirements unchanged, as determined by the selected authentication policy.

26. The processing system of claim 20, wherein the status information comprises the location of the processing system.

27. The processing system of claim 20, wherein processing devices comprise one or more of a cell phone, a smart phone, a personal computer, a tablet computer, a mobile Internet device, a music player device, a wireless router, a wireless access point, a telephone headset, a camera, a geographic positioning system device, an antenna, a remote control device, a television, an employee badge, a key fob, a smart card, a dongle, and a portable storage device.
